(19) United States
(12) Patent Application Publication
(10) Pub. No.: US 2013/0095404 A1
(43) Pub. Date: Apr. 18, 2013

(54) FUEL CELL SYSTEM

(71) Applicants: Kazunori SHIBATA, Owariasahi-shi (JP); Masaaki KONDO, Sunto-gun (JP)

(72) Inventors: Kazunori SHIBATA, Owariasahi-shi (JP); Masaaki KONDO, Sunto-gun (JP)

(21) Appl. No.: 13/692,612

(22) Filed: Dec. 3, 2012

Related U.S. Application Data
(63) Continuation of application No. 11/578,112, filed on Oct. 10, 2006.

(30) Foreign Application Priority Data
May 12, 2004 (JP) 2004-142139

(51) Int. Cl. H01M 8/04

(52) U.S. Cl. CPC H01M 8/04261
USPC 429/429

(57) ABSTRACT

The fuel cell system of the present invention supplies oxidant gas to a fuel cell during periods where generation of electrical power by the fuel cell is stopped. As a result, an amount of oxidant gas that is just sufficient to continue a reaction with remaining fuel gas is continued even when generation of electrical power itself is stopped. It is therefore possible to protect electrolyte membranes from damage occurring as a result of oxygen deficiency. Further, in addition to intermittent operation, the fuel cell system of the present invention is also applicable to steps for the stopping of generation of electrical power by a fuel cell in accordance with other conditions or at the time of the complete stopping of operation of the fuel cell system.

### CROSS-REFERENCE TO RELATED APPLICATIONS

This is a Continuation of U.S. patent application Ser. No. 11/578,112 filed Oct. 10, 2006, which in turn is a U.S. National Stage of International Application No. PCT/JP2005/009013 filed May 11, 2005, which claims the benefit of priority to Japanese Patent Application No. 2004-142139 filed May 12, 2004, the contents of which are incorporated herein by reference in their entirety.

### BACKGROUND OF THE INVENTION

1. Field of the Invention

The present invention relates to a fuel cell system.

2. Description of Related Art

In fuel cells, so-called cross-leakage where, at the time of stopping of electrical power generation, hydrogen gas on the anode side remaining within the fuel cell passes through an electrolyte membrane so as to move to the cathode side, and oxygen gas and nitrogen gas within air on the cathode side passes through the electrolyte membrane so as to move towards the anode side occurs. When cross-leakage occurs, there is damage to the electrolyte membrane. In order to prevent this, for example, in patent document 1, a fuel cell stopping method is disclosed where exhaust gas discharged from the cathode of the fuel cell at the time of stopping the supply of electrical power is re-circulated and supplied to the cathode. The generation of electrical power is then continued by residual oxygen in the exhaust gas so that the generation of electrical power is stopped when the electrical voltage generated becomes a predetermined value or less.
[Patent Document 1] Japanese Patent Laid-open Publication No. 2003-115317.

### SUMMARY OF THE INVENTION

However, in the above publicly known technology, as the concentration of the residual oxygen gradually falls, it is necessary to drive a compressor re-circulating the oxygen gas at a fixed rotational speed, and this cannot be said to be an operation stopping method with good fuel consumption.

Further, the aforementioned public technology relates to an operation method at the time of complete stopping of operation of the fuel cell system, and does not suppress deterioration of the electrolyte membrane of the fuel cell occurring during stopping periods of a sequential operation where the fuel cell operates in an intermittent manner so as to generate electrical power and stop generation of electrical power.

According to the experience of the applicant, in the periods where generation of electrical power is stopped during intermittent operation, when an oxygen deficient state intermittently occurs at the surface of the electrolyte membrane of the fuel cell, deterioration of the durability of the fuel cell is observed. Further, when the amount of oxidant gas becomes low in a state where residual hydrogen gas is present, an electrochemical reaction occurs between the oxidant gas and the residual hydrogen gas within the electrolyte membrane, and the electrolyte membrane is deteriorated by heat (heat of reaction). Namely, the method of consuming residual oxygen using the fuel cell stopping method as disclosed in the aforementioned public technology is not appropriate for suppressing deterioration of the electrolyte membrane occurring in the periods of stopping generation of electrical power of the intermittent operation where generation of electrical power and stopping of generation of electrical power are frequently repeated.

In order to resolve this situation, it is advantageous for the present invention to provide a control method capable of stopping generation of electrical power of a fuel cell system without deterioration in fuel consumption and while suppressing damage to an electrolyte membrane and suppressing thermal deterioration and a fuel cell system employing this control method.

In order to resolve the aforementioned problems, the fuel cell system of the present invention is provided with a fuel cell. This fuel cell is supplied with oxidant gas during periods where generation of electrical power is stopped.

In the above, with the fuel cell system of the related art, supply of oxidant gas to a fuel cell is stopped because of a period where electrical power is not being generated regardless of whether or not the system as a whole is operating, meaning that damage to and thermal deterioration of an electrolyte membrane is possible. In this respect, according to the present invention, oxidant gas is supplied even during periods where the fuel cell is not generating electrical power. This means that it is possible to avoid the drawbacks of the related art causes by deficiencies with respect to oxidant gas.

Here, “periods where generation of electrical power by a fuel cell is stopped” are cases where the fuel cell system is operating but generation of electrical power by the fuel cell is stopped such as in, for example, periods where generation of electrical power is stopped during intermittent operation. However, in addition to intermittent operation, the present invention is also applicable to steps for the stopping of generation of electrical power by a fuel cell in accordance with other conditions or at the time of the complete stopping of operation of the fuel cell system.

Further, it is preferable for the supply of oxidant gas to the fuel cell during periods where generation of electrical power by the fuel cell is stopped to be carried out intermittently. According to this configuration, it is possible to supply an appropriate amount of oxidant gas for periods where generation of electrical power is stopped by repeating an operation where supply is present and supply is not present (supply and non-supply) without changing the amount of supply of oxidant gas per unit time.

Moreover, it is also preferable for the supply of oxidant gas to the fuel cell during periods where generation of electrical power by the fuel cell is stopped to be carried out continuously. According to this configuration, if, for example, the supply of oxidant gas is continued while changing the amount of oxidant gas supplied, it is possible to supply an appropriate amount of oxidant gas in periods where generation of electrical power is stopped.

Further, it is preferable for the amount of oxidizing gas supplied to the fuel cell during periods where generation of electrical power is stopped to be taken to be greater than or equal to a minimum amount of oxygen supplied for preventing oxygen deficiency of the fuel cell. In doing so, if the amount of oxidant gas supplied so that oxygen deficiency does not occur is set in advance, an amount of oxidant gas in excess of this amount can be supplied during periods where generation of electrical power is stopped. An amount of oxidant gas that is sufficient to continue a reaction with remaining fuel gas can therefore be maintained even when generation of electrical power itself is stopped. It is therefore possible to protect an electrolyte membrane from damage and deterioration caused by oxygen deficiency.

Here, it is also preferable to ensure the amount of oxidant gas provided in such a manner that the flow of oxidant gas becomes uniform within the fuel cell (for example, a separator surface). In doing so, it is possible to further prevent the occurrence of localized states of oxygen deficiency and thermal deterioration.

It is also preferable for the amount of oxidant gas supplied in periods where generation of electrical power by the fuel cell is stopped is maintained to be less than a supply amount corresponding to the lower limit of an overdry region of the fuel cell.

Further, the fuel cell system of the present invention has a fuel cell and a driver supplying oxidant gas to the fuel cell. The driver takes in a supply amount of oxidant gas from outside during periods where generation of electrical power is stopped for the fuel cell that is less than for periods where the fuel cell generates electrical power. In addition to intermittent operation, this configuration is useful in steps for the stopping of generation of electrical power by a fuel cell in accordance with other conditions or at the time of the complete stopping of operation of the fuel cell system.

According to this configuration, oxidant gas can be supplied at an amount smaller than during electrical power generating periods during periods where generation of electrical power by the fuel cell is stopped. The power consumed by the driver can therefore be kept extremely small. On the other hand, oxidant gas supplied at this low supply amount is taken from outside and a sufficient concentration of oxygen gas is therefore ensured so that it is possible to suppress the occurrence of portions of the fuel cell that are oxygen deficient.

More specifically, it is appropriate for the amount of oxidant gas supplied in periods where generation of electrical power is stopped for the fuel cell to be maintained at a supply amount such that power consumed at the driver becomes a predetermined value or less.

Further, it is preferable for the average amount of the oxidant gas supplied per unit time to the fuel cell to be sequentially reduced during a transition of the fuel cell from a period of generating electrical power to a period where generation of electrical power is stopped.

Normally, sufficient oxidant gas is supplied at periods of generating electrical power, and there is a tendency for oxidant gas supplied in periods of generating electrical power to remain during periods where electrical power is not generated. Therefore, according to this configuration, the amount of oxidant gas supplied is gradually reduced to take into consideration the amount of oxidant gas remaining. Localized oxygen deficiency as a result of rapid stopping therefore does not occur, and a fuel cell can therefore be stopped in a stable and rapid manner.

Further, in the event that oxidant gas is continuously (continually) supplied, it is preferable for the amount of oxidant gas supplied to the fuel cell to be reduced linearly or asymptotically.

In this event, a method of implementing intermittent supplying by repeated supply and non-supply of oxidant gas at intervals (time intervals) that do not cause oxygen deficiency and then making intervals or supplying periods long while fixing the supply amount per unit time in supply periods, a method of gradually lowering the supply amount per unit time during supply periods of intermittent supply of oxidant gas while keeping the interval fixed, or a combination of both (methods implementing a combination of these) may be given as effective, more specific procedures for sequentially reducing oxidant gas.

In other words, it is preferable for the fuel cell system of the present invention to sequentially reduce the amount of oxidant gas supplied by supplying oxidant gas to the fuel cell at a predetermined supply amount per predetermined period or unit time every predetermined time interval, making the predetermined time intervals gradually longer, making the predetermined intervals gradually shorter, gradually reducing the predetermined supply amount per unit time, or by combination of some or all of these.

Further, from a further perspective, the present invention is characterized by a fuel cell system where oxidant gas is supplied to a fuel cell during periods where generation of electrical power by the fuel cell is stopped.

Further, it is preferable for the supply of oxidant gas to the fuel cell during periods where generation of electrical power by the fuel cell is stopped to be carried out intermittently.

Moreover, it is also preferable for the supply of oxidant gas to the fuel cell during periods where generation of electrical power by the fuel cell is stopped to be carried out continuously.

Further, it is preferable for the amount of oxidant gas supplied during periods where generation of electrical power by the fuel cell is stopped to be greater than or equal to a minimum oxygen supply amount for preventing oxygen deficiency of the fuel cell.

Moreover, the present invention is characterized by a fuel cell system provided with a driver for supplying oxidant gas where oxidant gas of a supply amount smaller than during periods where the fuel cell is generating electrical power is taken in from outside by the driver.

Further, it is preferable for the average amount of the oxidant gas supplied per unit time to be sequentially reduced during a transition of the fuel cell from a period of generating electrical power to a period where generation of electrical power is stopped.

In the above, according to the present invention, oxidant gas is supplied to a fuel cell even in periods where generation of electrical power by the fuel cell is stopped. It is therefore possible to stop generation of electrical power by the fuel cell while suppressing damage and thermal deterioration of an electrolyte membrane.

### BRIEF DESCRIPTION OF THE DRAWINGS

FIG. 1 is an overall view showing a configuration for a first embodiment of a fuel cell system of the present invention;

FIG. 2 is a flowchart showing an example of an operation (procedure for an operating method) of a fuel cell system of the first embodiment;

FIG. 3 is a view schematically showing the relationship between the amount of air (oxidant gas) supplied to the fuel cell and durability of the electrolyte membrane in which oxygen deficiency is caused;

FIG. 4 is a view schematically showing the relationship between the amount of air (oxidant gas) supplied to the fuel cell and the consumed power;

FIG. 5 is a view schematically showing change in current density occurring at electrical power generation periods and periods where generation of electrical power is stopped for an intermittent operation mode;

FIG. 6 is a view schematically showing the amount of air supplied for the present invention occurring at electrical power generation periods and periods where generation of electrical power is stopped for an intermittent operation mode;

FIG. 7 is a view schematically showing control of the amount of air supplied for periods where generation of electrical power is stopped in an operation method of a second embodiment;

FIG. 8 is a view schematically showing control of the amount of air supplied for periods where generation of electrical power is stopped in an operation method (modified example) of the second embodiment;

FIG. 9 is a view schematically showing control of the amount of air supplied for periods where generation of electrical power is stopped in an operation method of a third embodiment;

FIG. 10 is a view schematically showing control of the amount of air supplied for periods where generation of electrical power is stopped in an operation method (modified example 1) of the third embodiment; and

FIG. 11 is a view schematically showing control of the amount of air supplied for periods where generation of electrical power is stopped in an operation method (modified example 2) of the third embodiment.

### DETAILED DESCRIPTION OF THE INVENTION

The following is a description with reference to the drawings of preferred embodiments of the present invention. Dimensional proportions as shown in the drawings are by no means limited to the proportions shown in the drawings. Each of the embodiments is provided simply as a possible form of the present invention and are by no means limit application of the present invention.

### First Embodiment

The first embodiment is applicable to fuel cell systems mounted on a moving body, such as vehicles such as electric vehicles etc., boats, robots, and portable mobile terminals, and the present invention is applicable to special control of stopping of electrical power generation (in particular, control of stopping of generation of electrical power occurring in periods of stopping generation of electrical power during intermittent operation).

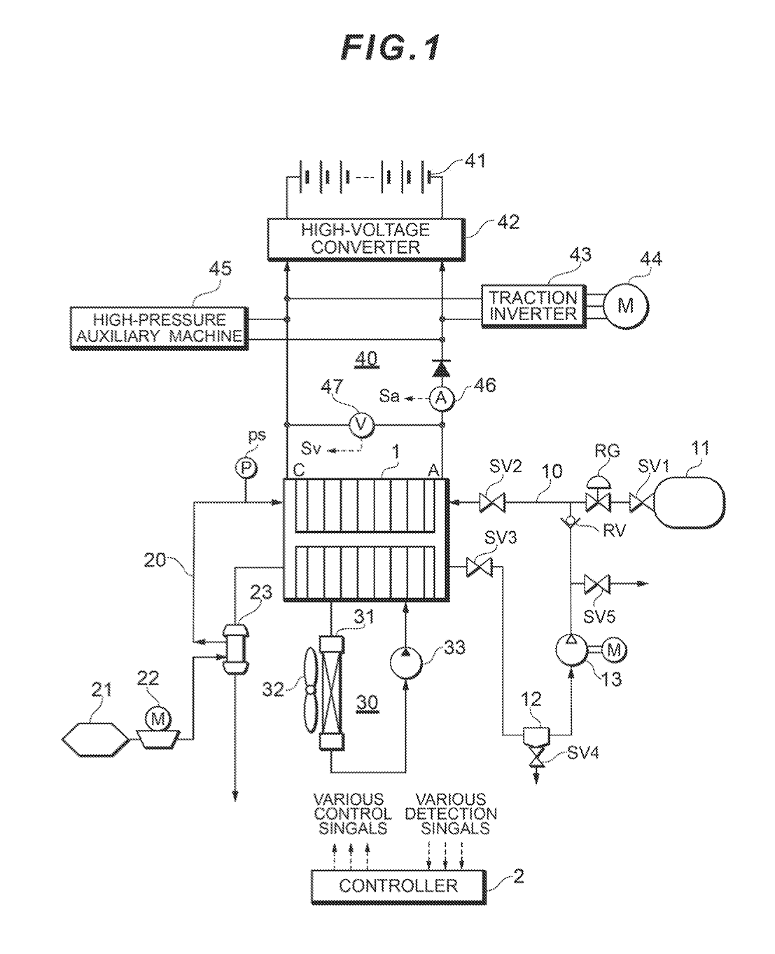

FIG. 1 is an overall view showing a configuration for this fuel cell system. As shown in FIG. 1, the fuel cell system is equipped with a fuel gas system 10 for supplying hydrogen gas that is fuel gas to a fuel cell stack 1, an oxidant gas system 20 for supplying air as an oxidant gas, a cooling system 30 for cooling the fuel cell stack 1, and a power system 40.

The fuel cell stack 1 has a stacked structure where a plurality of cells comprised of separators having paths for hydrogen gas, air, and cooling liquid and an MEA (Membrane-Electrode Assembly) sandwiched by a pair of separators are stacked one on top of another.

The MEA has a structure where a high polymer electrolyte membrane is sandwiched between two electrodes of an anode and a cathode. The anode is constituted by a catalytic layer for anode use provided on a porous support layer and the cathode is constituted by a catalytic layer for cathode use being provided on a porous support layer. The fuel cell causes a reverse reaction to the electrolysis of water, with hydrogen gas that is fuel gas supplied to the anode (positive electrode) side and oxidant gas (air) supplied to the cathode (negative electrode) side. As a result, a reaction expressed by the following equation (1) occurs on the anode side and a reaction expressed by equation (2) occurs on the cathode side so that electrons circulate and current flows.

H₂→2H⁺+2e⁻ (1)

2H⁺+2e⁻+(½)O₂→H₂O (2)

Fuel gas system 10 is equipped with a fuel tank 11 as a hydrogen gas supply source, source valve SV1, regulating valve RG, fuel cell inlet shut-off valve SV2, and upon passing through fuel cell stack 1, fuel cell outlet cut-off valve SV3, vapor-liquid separator 12, cut-off valve SV4, hydrogen pump 13, and check valve RV.

The hydrogen tank 11 is filled up with high-pressure hydrogen gas. In addition to taking a high-pressure hydrogen tank as a hydrogen supply source, application of various items such as a hydrogen tank employing a hydrogen storage alloy, a hydrogen supply mechanism using reformed gas, a liquid hydrogen tank, or a liquid fuel tank, etc. is also possible.

The source valve SV1 controls the supply of hydrogen gas. The regulating valve RG regulates the pressure of a downstream circulation path. The fuel cell inlet shut-off valve SV2 and outlet shut-off valve SV3 can be closed at the time of stopping of electrical power generation of the fuel cell. At the time of normal operation, the vapor-liquid separator 12 removes moisture and other impurities generated as a result of an electrochemical reaction of the fuel cell stack 1 from the hydrogen-off gas and discharges the moisture and impurities to outside via the cut-off valve SV4. The hydrogen pump 13 forcibly circulates hydrogen gas within the circulating path. An exhaust path is connected in a branching manner at the front of check valve RV and a purge valve SV5 is provided above the discharge path.

The oxidant gas system 20 is equipped with an air cleaner 21, compressor 22 and humidifier 23. The air cleaner 21 purifies external air and takes this air into the fuel cell system. The compressor 22 (driver) compresses outside air (air constituting oxidant gas) taken in at a rotational speed designated by the controller 2 and supplies this air to the fuel cell stack 1. The amount of air supplied to the fuel cell stack 1 at periods where generation of electrical power is stopped in intermittent operation or at times where operation of the fuel cell system is stopped completely can therefore be decided by controlling the rotational speed of the compressor 22. The humidifier 23 exchanges moisture between the compressed air and the air-off gas and subjects the compressed air to the appropriate humidity.

Air-off gas discharged from fuel cell stack 1 is mixed with hydrogen off gas discharged from the purge valve SV5 by a diluter (not shown) and is discharged.

Further, the cooling system 30 is equipped with a radiator 31, fan 32, and cooling water pump 33, with cooling liquid being supplied in such a manner as to circulate within the fuel cell stack 1.

The power system 40 is equipped with a battery 41, high-voltage converter 42, traction inverter 43, traction motor 44, high-pressure auxiliary apparatus 45, current sensor 46, and voltage sensor 47.

At the fuel cell stack 1, single cells are connected together in series or in parallel, and a predetermined high voltage (for example, approximately 500V) is generated between the anode A and cathode C as a result. The high-voltage converter 42 carries out voltage conversion between the fuel cell stack 1 and the battery 41 of different voltages, utilizes the power of the battery 41 as an auxiliary power supply for the fuel cell stack 1, and charges up the batter 41 with surplus power from the fuel cell stack 1. The traction inverter 43 converts a series current into a three-phase current and supplies this current to the traction motor 44. The traction motor 44 generates power to cause a wheel to rotate in the event that, for example, the moving body is a vehicle.

A motor such as the drive motor for the compressor 22, hydrogen pump 13, and fan 32 or a motor for the cooling water pump 33 etc. may be given as the high-pressure auxiliary apparatus 45. The current sensor 46 outputs a detection signal Sa corresponding to the electrical current generated by the fuel cell stack 1 and the voltage sensor 47 outputs a detection signal Sv corresponding to a terminal voltage of the fuel cell stack 1.

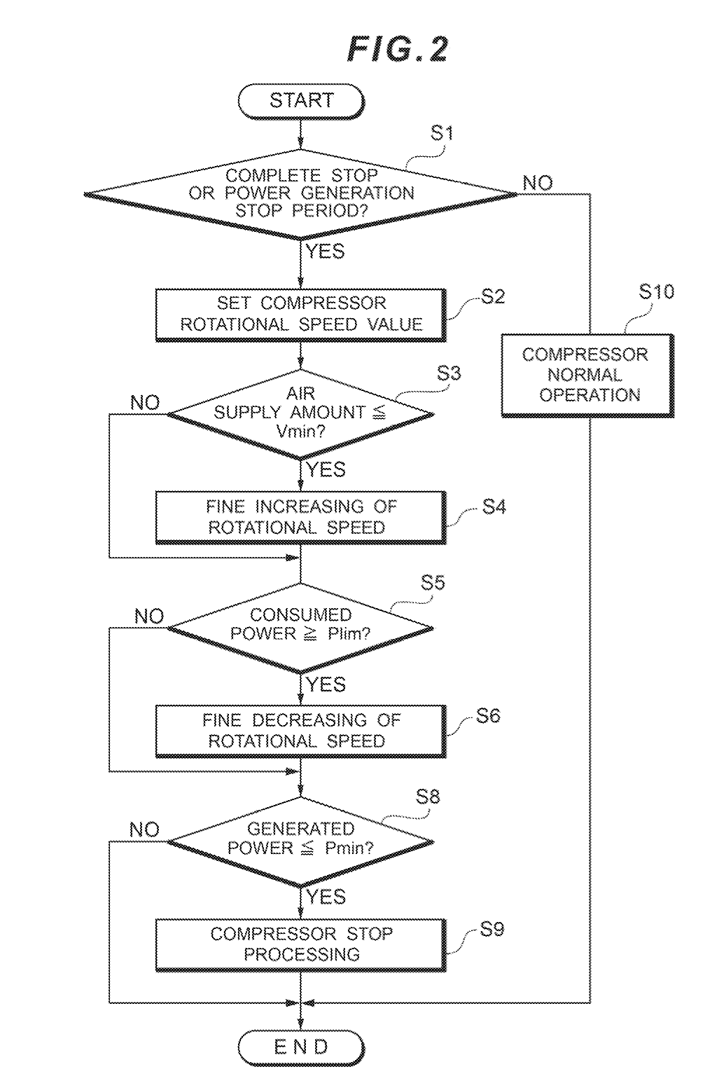

The controller 2 is a publicly known computer system used, for example, in control of a vehicle, with the fuel cell system operating in accordance with the procedure shown in FIG. 2 as a result of a CPU (Central Processing Unit) (not shown) sequentially executing a software program stored in ROM etc. (not shown).

Rather than being configured from a single microprocessor, the controller 2 is realized as a result of a number of microprocessors implementing different program modules so that, as a result of the respective functions operating in co-operation, it is possible for a wide variety of functions including the method to which the present invention is applied to be implemented.

Next, a description is given of the operation of the fuel cell system of the first embodiment.

The intermittent operation mode of this embodiment is an operation mode for improving fuel consumption at the time of light loads, and is an operation mode where fixed periods where the fuel cell generates electrical power and fixed periods where the fuel cell does not generate electrical power are repeated. Operation control (stop control) in the fuel cell system of the first embodiment is applied to the period where generation of electrical power is stopped for this intermittent operation mode. Specifically, at a period of stopping generation of electrical power of fuel cell stack 1 at the time of intermittent operation, an amount of supply of air (oxidant gas) that is more than the lowest amount of supply of oxygen so that the fuel cell stack 1 is not subjected to oxygen deficiency or thermal deterioration is maintained.

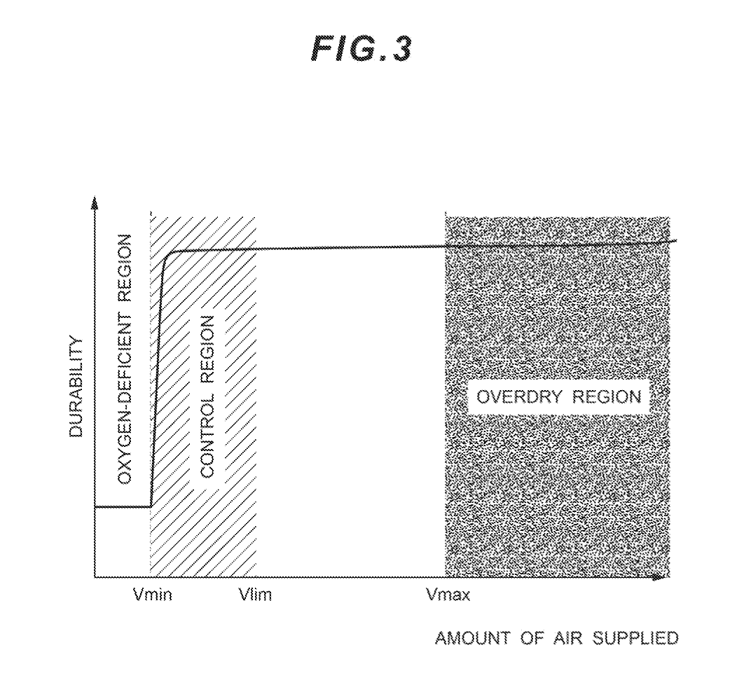

Here, the relationship between the amount of air supplied to the fuel cell and durability of the electrolyte membrane causing oxygen deficiency is shown in FIG. 3. Durability is an item (index) relatively indicating the extent to which damage is incurred by the high polymer electrolyte membrane, with damage being more easily incurred for a low durability so that lifespan becomes shorter, and damage being less easily incurred for a high durability, with lifespan then being longer.

As can be determined from FIG. 3, there is a tendency for durability of a high polymer electrolyte membrane to drop dramatically when the amount of oxygen falls below a predetermined minimum amount of oxygen supplied so as to enter a region of insufficient oxygen. When the amount of air supplied that is capable of ensuring the amount of oxygen corresponding to this minimum oxygen supply amount is taken to be a minimum air supply amount Vmin, if the amount of air supplied to the fuel cell is greater than or equal to this minimum air supply amount Vmin, the durability of the fuel cell can be maintained. This minimum air supply amount Vmin constitutes a lower limit for an amount of air supplied to a control region for compressor driving occurring in periods where electrical power generation is stopped for the fuel cell stack of the present invention.

Further, in this embodiment, a control region is determined taking into consideration requirements from the point of view of electrical power as well as the durability of the high polymer electrolyte membrane. Namely, the amount of air supplied in periods for the fuel cell stack 1 where generation of electrical power is stopped is maintained in a range of a supplied amount that ensures that power consumed at the compressor 22 is a predetermined value or less.

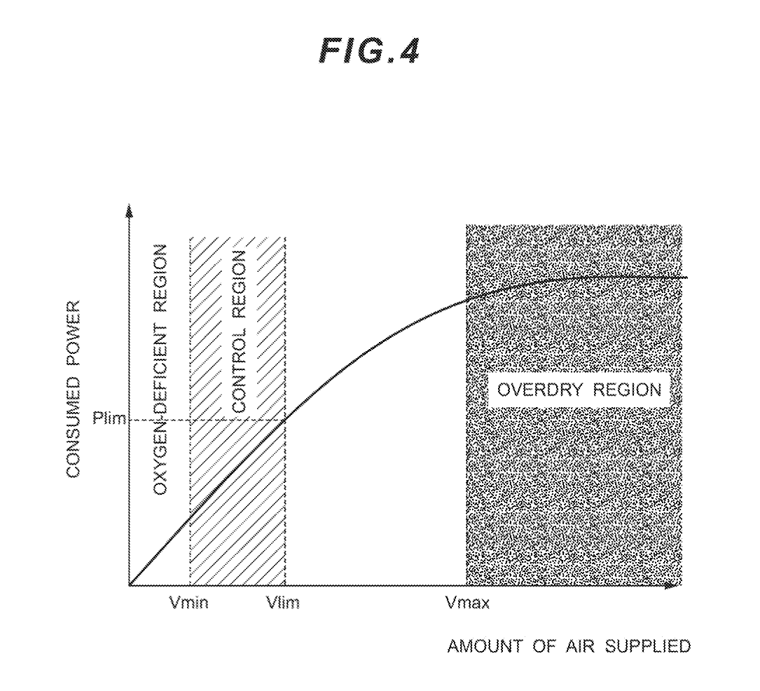

The relationship between the amount of air supplied to the fuel cell and the consumed power is shown in FIG. 4. The driver of the compressor 22 etc. raises the power consumed so that the rotational speed increases and the amount of air supply that is it possible to output increases. The amount of air supplied increases in a manner substantially correlating with the power consumed up to a certain extent but the consumed power levels off (becomes saturate) with the increase in the amount of air supplied.

In this fuel cell system, the required amount of oxygen (the amount of oxygen required by the reaction of equation (2)) decided by equation (2) fluctuates according to the required output power value required by the fuel cell but when the amount of surplus air in the amount of air supplied is substantial, the amount of water that is to be removed from the surface of the MEA high polymer electrolyte membrane becomes too large, and the efficiency with which electrical power is generated falls. This kind of region then constitutes the overdry region shown in the same drawing. During electrical power generating periods of fuel cell stack 1, the rotational speed of the compressor 22 is controlled in such a manner that the amount of air supplied is less than the maximum air supply amount Vmax that is the lower limit of this overdry region.

At a region where the amount of air supplied is comparatively small, the power consumed by the compressor 22 increases as the rotational speed becomes faster and as the amount of air supplied becomes more plentiful. In order to suppress power consumption, it is preferable for the rotational speed of the compressor 22 to be kept low in order to be within a range where the necessary amount of air can be ensured. Here, a consumed power upper limit Plim in a period where generation of electrical power by the fuel cell stack 1 is stopped is decided as a value that does not interfere with control in a range exceeding the minimum air supply amount Vmin described above, and the amount of air supplied at the time of driving the compressor 22 using this consumed power is taken to be a consumed power suppression air supply upper limit value Vlim. This is then taken as an upper limit for the control region of the compressor driving at periods where generation of electrical power is stopped.

Further, in this embodiment, a supply amount is set in such a manner that it is possible to maintain a uniform supply of oxygen (oxidant gas) at each cell of the fuel cell stack 1. Namely, in the case of driving the compressor 22 at the control region shown in FIG. 3, the amount of air supplied is relatively small compared to the voltage generation period, and the amount of air flowing in the separators containing the MEA is made small.

A contact surface area is therefore maintained between the air and the electrolyte membrane at the separators and a path of a complex shape is provided in order to ensure transit time. The shape of the path then constitutes resistance to air flowing at the separator surface so that even if air flows at the fuel cell as a whole, air is retained in a localized manner and portions that are deficient in oxygen occur.

Here, in this embodiment, an amount of supplied air that is such that oxygen deficient states do not occur as a result of air flowing at roughly any portion of a unit cell is set as a uniform air supply minimum value, as a minimum value characteristic of the fuel cell. This uniform air supply lower limit value is set for each separator shape using experimentation etc. in order to give an element that incurs the influence of a single cell separator shape. If this uniform air supply lower limit value is larger than the minimum air supply amount Vmin for preventing oxygen deficiency, the uniform air supply lower limit value is set as the lower limit value for the control region of the air supply occurring at periods where generation of electrical power is stopped.

In the above, a compressor 22 is driving in an air supply control region determined by a minimum air supply amount (minimum oxygen supply amount) for preventing an oxygen deficient state at the high polymer electrolyte membrane, a consumed power suppression air supply upper limit value for suppressing consumed power, and a uniform air supply lower limit value (minimum oxygen supply amount) for preventing localized oxygen deficiency.

The range of this air supply amount for the limit region is a total amount of 20 to 50NL/min for fuel cell stack 1 stacking, for example, four hundred unit cells, i.e. 0.05 to 0.125NL/min per cell.

A flowchart for when the compressor 22 is driven in the air supply control region is shown in FIG. 2 as an example of the operation (procedure for the operating method) of the fuel cell system of the first embodiment. The processing routine shown in this flowchart may be executed periodically at the time of execution (operating time) of this fuel cell system or may be executed in an irregular manner. Each processing item on this flowchart is provided in an approximate order that may be changed providing that the object of the present invention is still achieved.

In FIG. 2, if there is an electrical power-generating period of the fuel cell stack 1 in an intermittent operation mode (intermittent operation state) of the fuel cell (S1: NO), the controller 2 drives the compressor 22 at a rotational speed determined by calculations based on the output power required for the fuel cell (S10).

In the event of entering an electrical power generation stopped period of intermittent operation (S1: YES), controller 2 drives the compressor 22 at a rotational speed set in advance in such a manner as to enter the control region shown in FIG. 3 (S2). This set rotational speed is exemplified by a rotational speed assumed to give an air supply amount corresponding, for example, to the vicinity of the center of the control region.

The controller 2 carries out the following control in such a manner that the amount of air supplied at an electrical power generating stopped period is maintained within the range of the control region.

Namely, a detection signal etc. for a pressure sensor ps is referred to, controller 2 measures the amount of air supplied, and checks whether or not the amount of air supplied is less than the lower limit value Vmin for the control region (the lower limit value for the minimum air supply amount or the uniform air supply lower limit value) (S3). In the event that the amount of air supplied is less than the lower limit value Vmin (S3: YES), it is considered that the fuel cell has entered an oxygen deficient region (FIG. 3) where the fuel cell is in a localized oxygen deficient state, and the controller 2 outputs a drive signal in such a manner as to raise the rotational speed of the compressor 22 (S4).

On the other hand, when the amount of air supplied is greater than or equal to the upper limit value Vlim of the control region (S5: YES), too much power is consumed by the compressor 22. The controller 2 therefore outputs a drive signal in such a manner that the rotational speed of the compressor 22 is slightly reduced (S6).

Further, there are also cases where air supply processing in the electrical power generating stopped period is executed at the time operation of the fuel cell system has stopped completely. In this kind of case, supply of hydrogen gas that is the fuel gas is stopped, and generated electrical power of the fuel cell falls. It is no longer necessary to supply air at the time where operation stops completely with the limit that deterioration of the high polymer electrolyte membrane does not occur.

In the event that it is understood from the current sensor 46 and voltage sensor 47 that the electrical power generated is less than the predetermined value Pmin (S8: YES), the controller 2 consumes any remaining hydrogen gas, determines whether oxygen deficiency occurs at the surface of the high polymer electrolyte membrane of the MEA or whether thermal deterioration occurring as a result of hydrogen gas permeating from the anode side to the cathode side no longer occurs, and stops driving of the compressor 22 (S9).

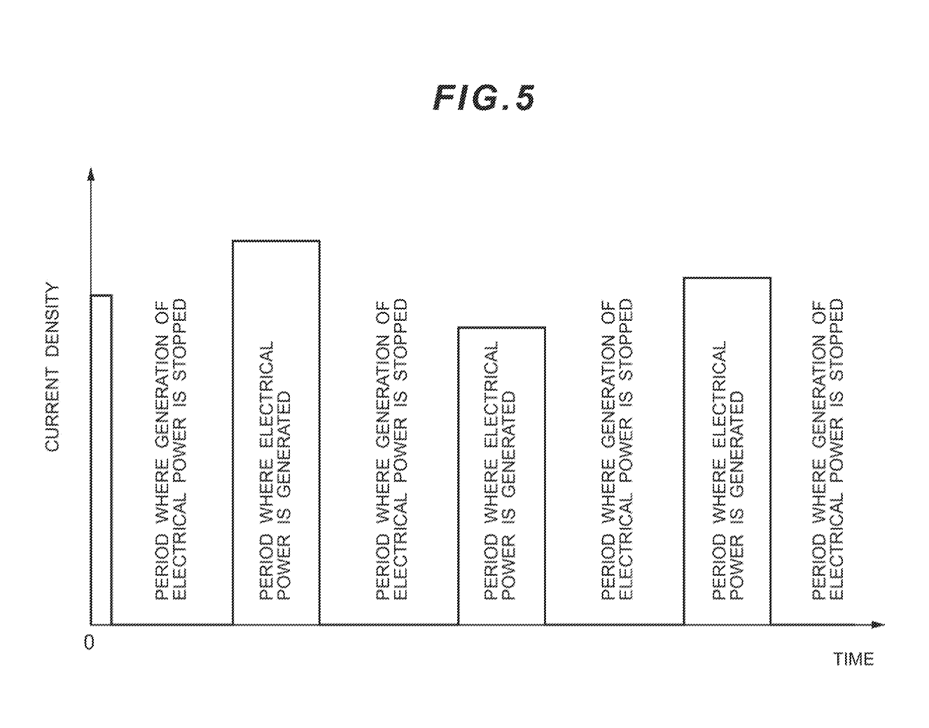

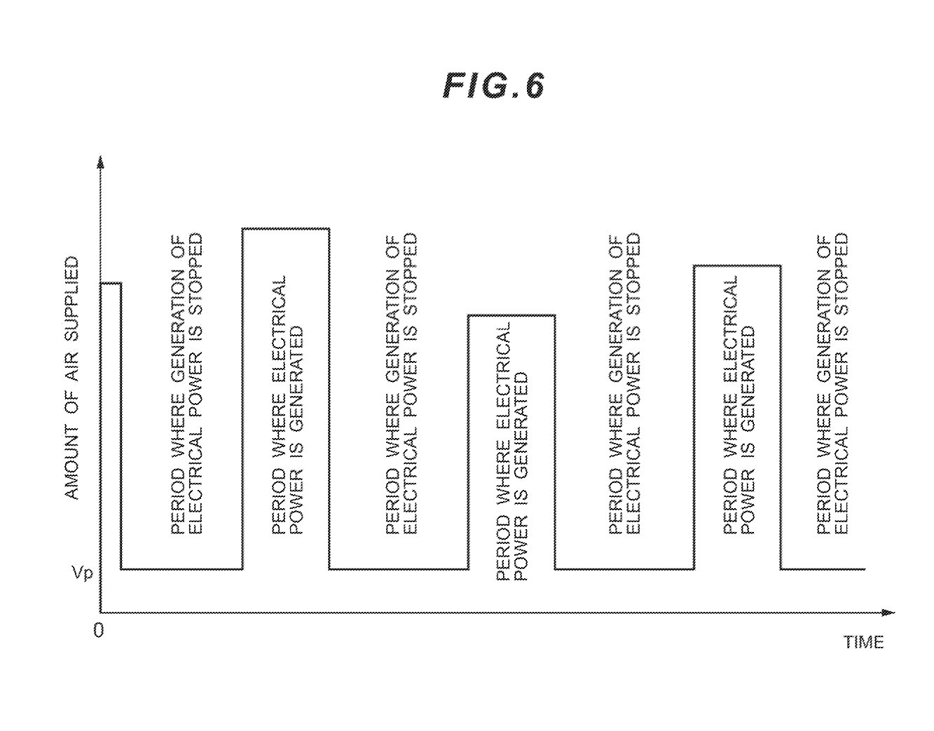

The manner in which current density of each cell of each fuel cell changes corresponding to the intermittent operation (intermittent operation) of the first embodiment is shown in FIG. 5. Further, the manner in which the amount of air supplied to the fuel cell stack 1 changes corresponding to the sequential mode is shown in FIG. 6.

The intermittent operation mode alternately implements electrical power generating periods and periods where generation of electrical power is stopped for the fuel cell stack 1 at predetermined intervals. During electrical power generating periods, current flows as shown in FIG. 5 at each unit cell because power is consumed by the whole system, and an amount of air supplied is decided according to this, as shown in FIG. 6.

On the other hand, during periods where generation of electrical power is stopped for the fuel cell stack 1, current substantially does not flow, as shown in FIG. 5, as power is no longer consumed. However, the amount of supply of air is also maintained in a control region during periods where generation of electrical power is stopped, so that, for example, an average air supply amount Vp is maintained. With the system of the related art, the amount of air supplied during the periods where generation of electrical power is stopped is substantially zero. The fuel cell system of the present invention therefore differs substantially with the related art in regards to this point.

In this embodiment, the supply of air is carried out during periods where generation of electrical power by the fuel cell stack 1 is stopped but the operation procedure shown in the flowchart of FIG. 2 can be utilized as is as a countermeasure for preventing deterioration of the electrolyte membrane in cases where operation of the fuel cell system is stopped completely.

According to the fuel cell system of the first embodiment, an amount of air of an extent capable of suppressing damage due to oxygen deficiency at the surface of the high polymer electrolyte membrane of MEA and capable of suppressing thermal deterioration due to electrochemical reactions promoted by remaining hydrogen gas continues to be supplied during periods where generation of electrical power by the fuel cell is stopped. The fuel cell is therefore protected from damage that may occur due to oxygen deficiency and thermal deterioration, and durability and reliability are improved.

Further, the amount of air supplied to keep down power consumed by the compressor 22 is the upper limit and it is possible for the power consumption to be limited to as great an extent as possible within the range where oxygen deficiency and thermal deterioration of the high polymer electrolyte membrane can be suppressed.

Further, an amount of supply of oxygen of a range where the flow of air at the separator surface is uniform can be ensured and it is therefore possible to prevent the occurrence of localized oxygen deficient states.

Moreover, air supplied to the fuel cell stack 1 is taken in from outside. Air with a comparatively high concentration of oxygen is therefore supplied, and the occurrence of oxygen deficiency in a localized manner at the fuel cell can be suppressed.

### Second Embodiment

In the first embodiment, there is an abrupt change from the amount of air supplied for the period of generating electrical power to the supply of the restricted amount of air while the fuel cell goes from an electrical power generating period to a period where generation of electrical power is stopped, but in the second embodiment the amount of air supplied changes gradually. The fuel cell system used in this embodiment has the same structure as used in the first embodiment as exemplified by the fuel cell system shown in FIG. 1.

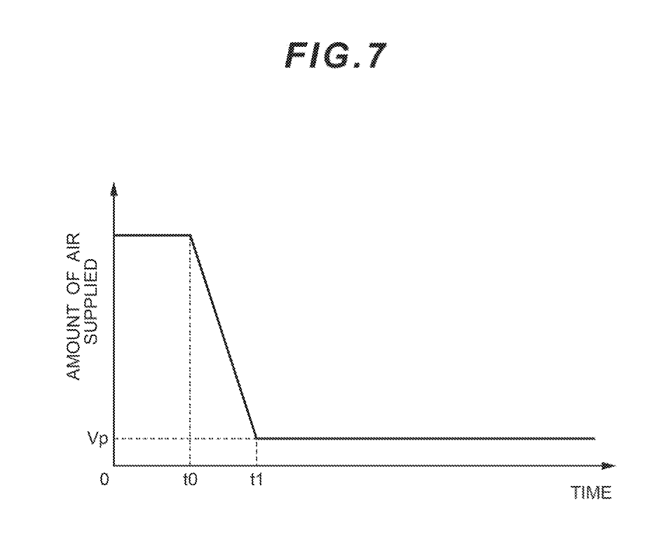

Control characteristics for the amount of air supplied from an electrical power generating period to a period where operation is stopped for the fuel cell of the second embodiment is shown in FIG. 7. FIG. 7 shows change in the amount of air supplied between the electrical power generating period and the period of stopping generation of electrical power shown in FIG. 6 in an enlarged manner.

In FIG. 7, up to a time t0 is an electrical power generating period, and from time t0 is a transition to a period of stopping generation of electrical power. The controller 2 controls the rotational speed of the compressor 22 in such a manner that the amount of air supplied from the time (time t0) where the electrical power generation period ends reduces. At time t1, the amount of control (amount of air supplied) becomes the average air supply amount Vp described for the first embodiment and the amount of air supplied thereafter stabilizes in accordance with the procedure shown in the flowchart of FIG. 2.

When the amount of air supplied changes dramatically, air disturbances occur due to fluctuations in the amount supplied. Depending on the case, it is therefore possible that localized states of air deficiency may occur. With regards to this, in the second embodiment, control is exerted in such a manner that the amount of air supplied is sequentially (gradually) changed. The amount of remaining oxygen immediately before the period of stopping the generation of electrical power of the fuel cell is gradually changed and as a result the occurrence of localized oxygen deficiency is less likely.

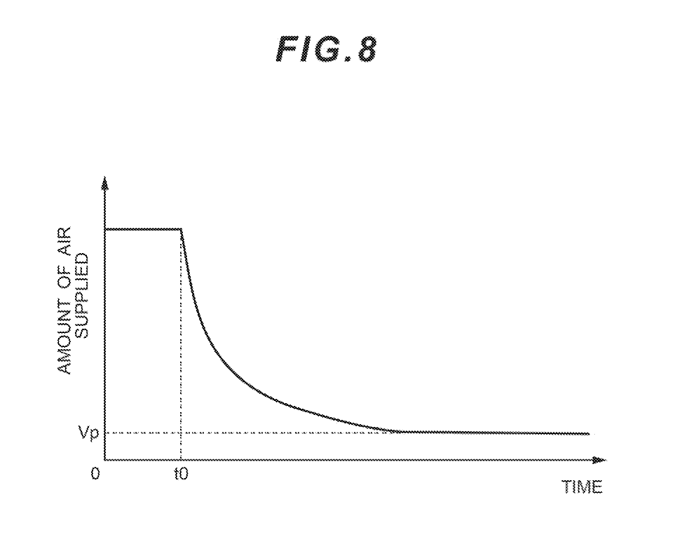

It is of course possible to change the amount of air supplied asymptotically as shown in FIG. 8 instead of changing the amount of air supplied in a linear manner.

### Third Embodiment

In the first embodiment, the amount of air supplied is limited in periods where the fuel cell stops generation of electrical power. However, in a third embodiment, and example is described where the amount of air supplied is made to change intermittently. The fuel cell system used in this embodiment has the same structure as used in the first embodiment as exemplified by the fuel cell system shown in FIG. 1.

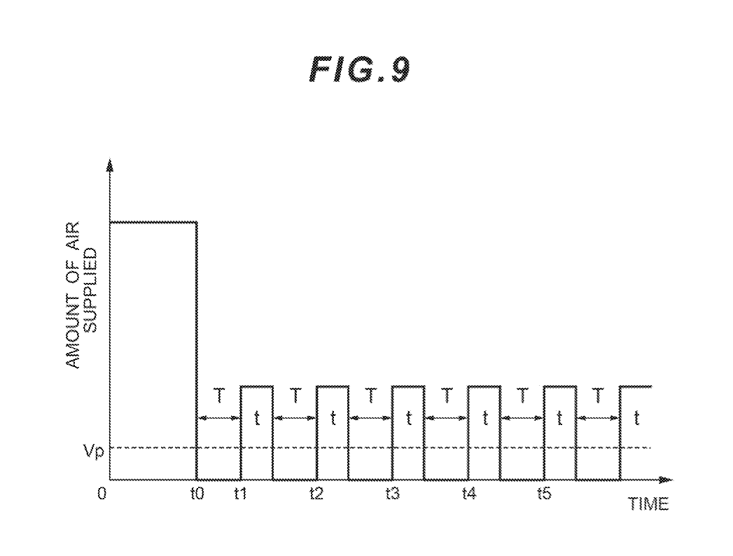

Control characteristics for the amount of air supplied from periods where electrical power is generated to periods where generation of electrical power is stopped for the fuel cell of the third embodiment is shown in FIG. 9. FIG. 9 is an enlarged view showing change in the amount of air supplied between periods of generating electrical power and periods where generation of electrical power is stopped shown in FIG. 6.

As shown in FIG. 9, the same amount of air continues to be supplied for just a fixed period of time t in a fixed interval T from the time (t0) of stopping of the electrical power generating period. An average value for this intermittent supply of air is Vp shown in FIG. 6. The interval T is set as a period in such a manner that oxygen deficiency does not occur due to remaining oxygen at the fuel cell even if there is no supply of air at all. Controller 2 exerts control in such a manner that the compressor 22 is driven by just the period t at the same rotational frequency each interval T from (time t0) at the time of ending of a period where electrical power is generated.

There are also cases where a stable supply of air is difficult at an air supply amount suppressed in the control region by the state of the compressor. For example, there are cases where the minimum drive rotational speed is high to a certain extent. In these cases also, according to the third embodiment, it is possible to finely control the average amount of air supplied as a result of intermittent driving by the compressor.

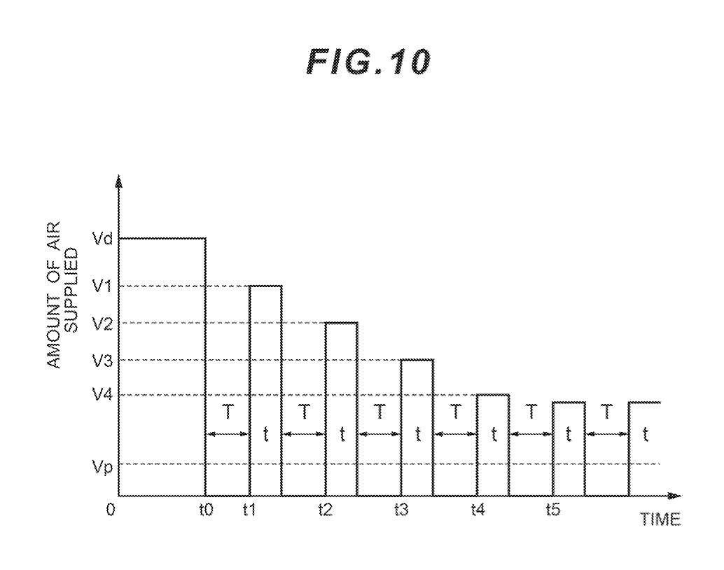

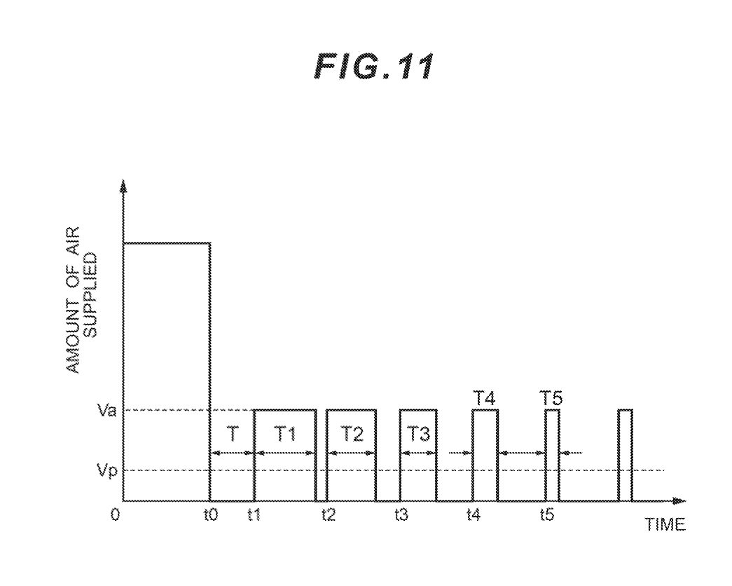

Rather than fixing the rotational speed for intermittent operation during periods of stopping generation of electrical power, as shown in FIG. 10, the rotational speed is changed every driving interval T, and as a result, it is possible to change the amount of air supplied each period t every interval T. As shown in FIG. 11, it is also possible to change the compressor drive periods T1 to T5 so that the amount of air supplied at each period T1 to T5 every interval T changes as a result. It is also possible to change both the rotational speed and the compressor drive period. In either case, the average amount of air supplied is substantially asymptotic as shown in the second embodiment.

### Further Embodiments

The present invention is by no means limited to each of the above embodiments and various modifications may be utilized without deviating from the essence of this invention. For example, various methods may be considered for control methods where the amount of air supplied in periods where generation of electrical power by the fuel cell is stopped is maintained in the limiting region, and the physical amount to be detected may also be changed appropriately. Further, the control timing and the amount of control of the compressor 22 is also by no means limited to that described for each of the embodiments.

The fuel cell system of the present invention supplies oxidant gas to the fuel cells even during periods where the generation of electrical power by the fuel cell has stopped. It is therefore possible to suppress damage to and thermal deterioration of the electrolyte membrane and stop generation of electrical power by the fuel cell. Broad utilization in equipment such as mobile bodies equipped with fuel cells, motors, and installations etc. is therefore possible.

1. A fuel cell system comprising:
a fuel cell supplied with oxidant gas during periods where generation of electrical power is stopped;
a driver configured to take in oxidant gas from outside; and
a controller programmed, in the periods where generation of electrical power is stopped, to measure a supply amount of the oxidant gas to the fuel cell, to control the driver in such a manner that a measured supply amount of oxidant gas is greater than or equal to a minimum amount of oxygen supplied for preventing oxygen deficiency of the fuel cell, and to stop driving of the driver when the electrical power generated by the fuel cell is less than a predetermined value.

2. The fuel cell system according to claim 1,
wherein supply of oxidant gas to the fuel cell during periods where generation of electrical power is stopped is carried out intermittently.

3. The fuel cell system according to claim 1,
wherein supply of oxidant gas to the fuel cell during periods where generation of electrical power is stopped is carried out continuously.

4. The fuel cell system according to claim 1,
wherein the amount of oxidant gas supplied to the fuel cell during periods where generation of electrical power is stopped is taken to be greater than or equal to a minimum amount of oxygen supplied for preventing oxygen deficiency of the fuel cell.

5. The fuel cell system according to claim 1,
wherein the driver takes in a supply amount of oxidant gas from outside that is less than for periods where the fuel cell generates electrical power during periods where generation of electrical power is stopped for the fuel cell.

6. The fuel cell system according to claim 1,
wherein the average amount of the oxidant gas supplied per unit time to the fuel cell is sequentially reduced during a transition of the fuel cell from a period of generating electrical power to a period where generation of electrical power is stopped.

7. The fuel cell system according to claim 1,
wherein the amount of the oxidant gas supplied in periods where generation of electrical power is stopped for the fuel cell is maintained at a supply amount such that power consumed at the driver becomes a predetermined value or less.

8. The fuel cell system according to claim 1,
wherein the amount of oxidant gas supplied in periods where generation of electrical power by the fuel cell is stopped is maintained to be less than a supply amount corresponding to the lower limit of an overdry region of the fuel cell.

9. The fuel cell system according to claim 1,
wherein the fuel cell is comprised of a plurality of cells,
the oxidant gas is air; and
the amount of air supplied in periods where generation of electrical power by the fuel cell is stopped is taken to be 0.05 to 0.125NL/min per single cell.

10. The fuel cell system according to claim 6,
wherein the amount of oxidant gas supplied to the fuel cell is reduced linearly or asymptotically.

11. The fuel cell system according to claim 2,
wherein the oxidant gas is supplied to the fuel cell for predetermined periods, and at a predetermined amount per unit time, every predetermined time interval, and
the predetermined time intervals become gradually longer.

12. The fuel cell system according to claim 2,
wherein the oxidant gas is supplied to the fuel cell for predetermined periods, and at a predetermined amount per unit time, every predetermined time interval, and
the predetermined time periods become gradually shorter.

13. The fuel cell system according to claim 2,
wherein the oxidant gas is supplied to the fuel cell for predetermined periods, and at a predetermined amount per unit time, every predetermined time interval, and
the predetermined supplied amount per unit time is gradually reduced.

14. The fuel cell system according to claim 1,
wherein the periods where generation of electrical power is stopped are periods where the fuel cell system operates but generation of electrical power by the fuel cells is stopped.

15. The fuel cell system according to claim 1,
wherein the periods where generation of electrical power is stopped are periods where generation of electrical power is stopped during intermittent operation of the fuel cell.
